(19) United States
(12) Patent Application Publication
(10) Pub. No.: US 2005/0030272 A1
(43) Pub. Date: Feb. 10, 2005

(54) Electro-optical device and driving method thereof, projection-type display device, and electronic apparatus

(75) Inventor: Hiroyuki Hosaka, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/885,698

(22) Filed: Jul. 8, 2004

(30) Foreign Application Priority Data
Jul. 14, 2003 (JP) 2003-196499
Apr. 30, 2004 (JP) 2004-135926

(51) Int. Cl. G09G 3/36

(52) U.S. Cl. 345/92

(57) ABSTRACT

An exemplary embodiment provides an electro-optical device having an improved display quality of moving picture, while obtaining the display uniformity in a screen by suppressing a crosstalk. The electro-optical device according to the invention can include a plurality of pixels are arranged in an image display region and a driving circuit unit for driving the pixels in a matrix. The driving circuit unit divides data of one frame into a plurality of data corresponding to a plurality of fields, one of data of two continuous fields being image data and the other being black display data. The data of the two continuous fields is alternately written in every one horizontal period while changing the starting time of the writing-in of each field within one vertical period, and the polarity of data signal is inversed fields against a predetermined electric potential between the two continuous. As a result, the image display region and black display region are simultaneously formed in a screen, and then the execution of a pseudo impulse-type display can be performed. Further, the occurrence of discrimination can be avoided since the pseudo field-inversion driving is executed every region. On the other hand, the crosstalk can be avoided since a line-inversion driving can be executed for the data line.

### BACKGROUND OF THE INVENTION

1 Field of Invention

The present invention relates to an electro-optical device and driving method thereof, projection-type display device, and electronic apparatus. More specifically, the invention relates to an electro-optical device that is suitable for a liquid crystal light valve mounted on the projection-type display device, and its driving method.

2. Description of Related Art

In related electro-optical devices, such as liquid crystal displays (LCDs), a blurring phenomenon that makes an image contour unclear can occur during the display of moving picture. The cause of the blurring phenomenon was thought to be a poor responsiveness of the liquid crystal. However, it has been recently been determined that the reason is due to the hold-type driving method in itself that continuously displays image. In the hold-type display devices, the previous image is continuously displayed until the image changes, while one observes the image of the previous frame due to the continuity of human eyes' following operation. As a result, a mismatch between the image movement and human eyes' movement occurs, so that it causes the blurring phenomenon.

To solve the above problem, in JP2000-10076A, the field-inversion driving method (field-inversion driving method) that divides one frame into two fields and makes a first field transmitted and a second field non-transmitted is proposed by using the operation characteristics of a mono-stabilized liquid crystal material, where the transmission of light is analog-controlled in one polarity while the transmission of light is not allowed in the other polarity.

### SUMMARY OF THE INVENTION

However, in the case of the field-inversion driving method, crosstalk can easily occur due to the high voltage variation during the holding period. In addition, non-uniform luminance problems can occur in the up-down direction of a liquid crystal display panel. In other words, for one data line of the field-inversion driving method, the image signal with same polarity is written in from a field for all pixels where the signal is provided from the corresponding data line. In addition, the polarity of the image signal that is provided to the corresponding data line is inversed once it is moved to the next field. At that time, when the scanning line is scanned from top to bottom of an image display region, the image signal is written in the upper pixels in the display region. And then, the polarity of the image signal that is applied in the corresponding data line has the same polarity as the electric potential of the pixel during most of time of the holding period. However, after the image signal is written in the lower pixels, the image signal having a polarity opposite to the electric potential of the pixel is applied in the data line during most of the holding period. As a result, the leaking voltage through the off-resistance of a switching element increases as much as that of the lower pixel in the screen, resulting in non-uniform brightness of upper and lower regions in the screen.

It is an aspect of the invention to provide an electro-optical device and a driving method thereof, a projection-type display device, and electronic apparatus that is possible to improve the display quality of moving picture while obtaining the display uniformity in the screen by suppressing the crosstalk.

An electro-optical device according to the invention can include a plurality of pixels are arranged in an image display region and a driving circuit unit for driving the pixels in a matrix. The driving circuit unit divides one frame into a plurality of continuous fields, one of data of two continuous fields being image data and the other being black display data. The data of the two continuous fields is alternately written in every one horizontal period while changing the starting time of the writing-in of each field within one vertical period, and the polarity of data signals is inversed between the two continuous fields centering a predetermined electric potential. The invention makes it possible to execute an impulse-type display by installing the black display field in a frame (that is, insert a black image in the image).

At this time, in the invention, the writing-in of the image of the next field begins in the midst of the writing-in of the image of the previous field, unlike the conventional field-inversion driving method where the writing-in of the image of the next field begins after writing-in all of the image of the previous field. In addition, in the invention, since the polarity of data is inversed between continuous fields by making a polarity of data in one field have one of a positive electric potential or a negative electric potential, applied regions of the positive electric potential and negative electric potential with some extent of width are formed for each field in the screen when viewed from an arbitrary one vertical period. As a result, the occurrence of disclination can be avoided within each region due to the same polarity of neighboring pixels, like the field-inversion driving method.

In addition, the same operation as the conventional line-inversion driving can be executed for the data line side because the data of each field is alternately output in the present invention. For this reason, there is a little difference between the potentials of the pixel electrode and data line in upper and lower pixels of the screen like the field-inversion driving of the data line side, and the crosstalk or the display non-uniformity according to the region in the screen can be avoided.

However, it is preferable that the data polarity for each field be inversed every one vertical period. By executing the inversion driving every field, we can make the effect of the field-inversion more efficient. In addition, it is preferable that the starting time of the writing-in of each field be variably controlled.

As stated above, although the image blurring is suppressed in the present invention by the execution of the impulse-type display, the image gets dark as a whole due to the insertion of the black image in an image. In the conventional field-inversion driving, the display brightness is determined by the ratio of the amount of the image data and the amount of the black image data. In the case where the image display and black display are alternately executed every one vertical period (that is, the amount of the image data is the same as the amount of the black image data), the display brightness is halved in comparison with the absence of the black display.

Therefore, in the invention, since the image display data and black display data are alternately written in within the one vertical period, the image display and black display regions always exist in the screen, and the image of the previous written field (the previous field) is sequentially rewritten in by the image of the later written field (the next field). For this reason, as the interval of the starting time of the writing-in between the previous field and the next field is shortened, the period that the image of the previous field is held in the screen is shortened. To the contrary, as the interval is lengthened, the holding period is lengthened too.

For example, in the case that one frame data is divided into two continuous field data where a first field data is for the black display, and a second field data is for the image display, advancing the starting time for the writing-in of the second field shortens the holding period of the black image and brightens the display in spite of the amount of the data of each field being equal to each other. In contrast, delaying the starting time for the writing-in of the second field makes the display darker due to prolongation of the holding time of the black image. As the holding time of the black image is shortened, the suppression effect of the image blurring is reduced. Therefore, there is a tradeoff relationship between them. As a result, the display can be optimized according to the user environment and preference by variably controlling the starting time for the writing-in of each field based on the external information (for example, information based on the image signal, information based on the projection magnification, information based on the environmental brightness, and information based on the user preference).

In addition, an electro-optical device according to the invention can include a plurality of data lines and a plurality of scanning lines disposed to intersect to each other, a plurality of pixels arranged in an image display region to corresponding to intersections of the plurality of scanning lines and the plurality of data lines, and a driving circuit unit for driving the pixels in a matrix. The driving circuit unit can include a scanning driver for outputting n gate output pulses within one vertical period at a different timing and shifting the gate output pulses to the scanning lines apart from a predetermined interval every one horizontal period in synchronization with clock signals and a data driver for dividing one frame data into n data corresponding to continuous n fields, alternately providing each data line with the n data for the continuous n fields every one horizontal period, and inversing the polarity of the data signals between the continuous fields centering a predetermined electric potential. One of n enable signals that alternately rise every one horizontal period is assigned for each scanning line and the scanning signal is output for the scanning line selected from the gate output pulses and enable signals. At least one of n field data is for black display data. In addition, n is an integer more than two.

In this configuration, the same operation as the conventional line-inversion driving can be executed for the data line side. On the other hand, for the scanning line side, n gate output pulses make shift from the upper region to lower region of the screen in synchronization with the clock signal while rising from the different position of the scanning line in the screen within one vertical period, without one gate output pulse making shift sequentially from the upper region to lower region of the screen within one vertical period. In addition, the scanning signal is output to the scanning line that is selected by the enable signal among the scanning lines where the gate output pulse rises. For this reason, scanning is not sequentially performed from the upper region to lower region of the screen. Instead, scanning is back and forth performed across all the scanning lines by skipping some scanning lines (a plurality of scanning lines). As a result, the applied regions of the positive electric potential and negative electric potential with some extent of width are formed for each field in the screen when viewed during an arbitrary one vertical period.

In other words, this configuration specifies the above-described electro-optical device with regard to the configuration of a driver. Therefore, it is possible to obtain the same effect as the above-described one. Although the pseudo field-inversion driving is executed in each region, since the same operation as the conventional line-inversion driving is executed for the data line side, there is a little difference between the potentials of the pixel electrode and data line in upper and lower pixels of the screen like the field-inversion driving of the data line side, and the crosstalk or the display non-uniformity according to the region in the screen can be avoided. In addition, in this configuration, the display quality of moving picture is improved because at least one field is used as the black image to execute the impulse-type display.

In addition, in the above configuration, it is preferable that the polarity of data for each field be inversed every one vertical period. By executing the inversion driving every field, it is possible to make the effect of the field-inversion more efficient.

In addition, it is preferable that the output timing of the plurality of gate output pulses be variably controlled. In the above configuration, the writing-in of the corresponding field starts according to the output of the gate output pulses. However, as described above, the black display field and the interval of starting time of the writing-in of the following image display field determine the display brightness. As a result, the display can be optimized according to the user environment and preference by variably controlling the output interval of the gate output pulse based on the external information. For example, information based on the image signal, information based on the projection magnification, information based on the environmental brightness, and information based on the user preference.

In addition, in the invention, although it is possible to divide one frame data into more than three continuous field data in a driving circuit unit, it is preferable that the one frame data be divided into two continuous field data wherein one of the field data is for the image display data, the other is for the black display data so as to simplify the circuit configuration. In this configuration, since the image is also written in by the black image data when the image is written in every line by the external image data, the image is in fact written in with double speed (frequency is two times of that of the external image data). In common, although double-speed driving requires the frame memory corresponding to the two screens, outputting the external image data to the data line in itself forms the image in this configuration, removing the requirement of the frame memory.

In a method of driving an electro-optical device in which a plurality of pixels are arranged in an image display region, the method can include the steps of dividing one frame into a plurality of continuous fields, one of two continuous field data being image data and the other being black display data, alternately writing the two continuous field data in every one horizontal period while changing the starting time of the writing-in of each field within one vertical period, and inversing the polarity of data signals between the continuous fields centering a predetermined electric potential.

According to the driving method, the same effect can be obtained as the electro-optical device in the present invention. Since the applied regions of the positive electric potential and negative electric potential with some extent of width are formed for each field in the screen by alternately time-shifting and writing-in the image display field and black display field, the occurrence of discrination or the display non-uniformity according to the region in the screen can be avoided. On the other hand, since the same operation as the conventional line-inversion driving is executed for the data line side, the crosstalk can be suppressed. Of course, the display quality of moving picture is improved because the black image is inserted in the image to execute the impulse-type display.

A projection-type display device according to an aspect of the invention can include an illumination device, an electro-optical device that modulates light emitted from the illumination device, and a projection device that projects light modulated by the electro-optical device. According to the configuration, it is possible to implement the projection-type display device that features excellent display quality by including the electro-optical device according to the invention.

### BRIEF DESCRIPTION OF THE DRAWINGS

The invention will be described with reference to the accompanying drawings, wherein like numerals reference like elements, and wherein:

FIG. 1 is a plan view illustrating the schematic structure of a liquid crystal light valve according to a first embodiment of the present invention;

FIG. 2 shows a cross-sectional view taken along the line H-H′ of FIG. 1;

FIG. 3 shows an equivalent circuit of the plurality of pixels that constitute the liquid crystal light valve and are formed in a matrix;

FIG. 4 shows an exemplary block diagram including a driving circuit unit of the liquid crystal light valve;

FIG. 5 shows the circuit diagram that represents the structure of a scanning driver in the driving circuit unit;

FIG. 6 shows the detailed circuit diagram of the main part of FIG. 5;

FIG. 7 shows a timing chart illustrating the operation of the liquid crystal light valve;

FIG. 8 shows a timing chart that is abstracted from the main part of FIG. 7;

FIG. 9 shows a timing chart that is abstracted from the main part of FIG. 8;

FIG. 10 is a diagram illustrating the image of a screen of the liquid crystal light valve;

FIG. 11 illustrates the image of the screen;

FIG. 12 depicts the timing chart to describe the operation of the liquid crystal light valve of the second preferred embodiments;

FIG. 13 depicts the diagram to describe the movement of the screen;

FIG. 14 depicts the operation of the liquid crystal light valve; and

FIG. 15 shows the schematic configuration of an example of the projection-type liquid crystal device using the liquid crystal light valve.

### DETAILED DESCRIPTION OF PREFERRED EMBODIMENTS

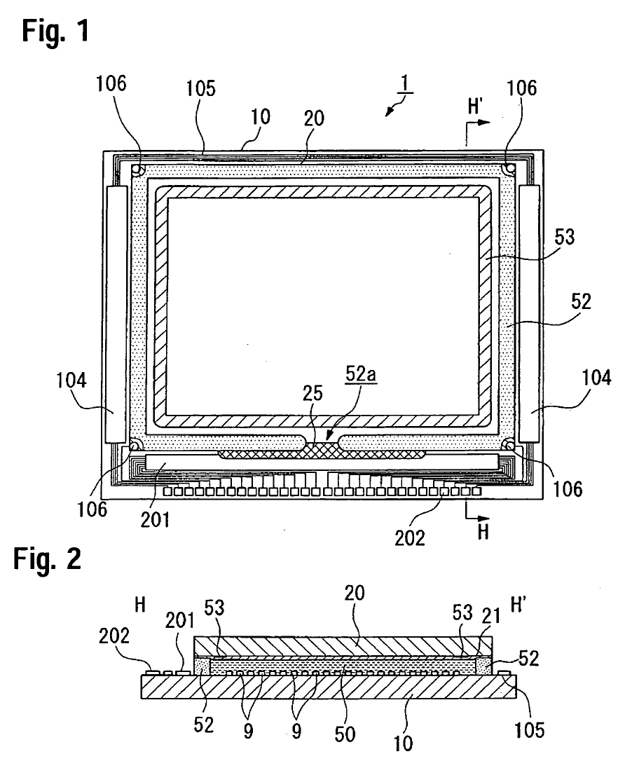

Hereinafter, a first preferred embodiment of the invention will be described in detail with reference to the FIGS. 1 to 10.

In the present embodiment, a liquid crystal light valve (liquid crystal device) that is used as an optical modulator of a projection-type display device among the electro-optical devices will be described by taking an example.

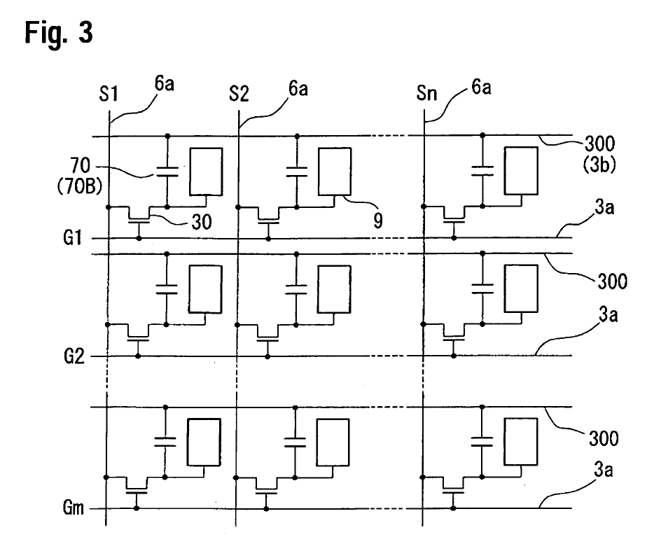

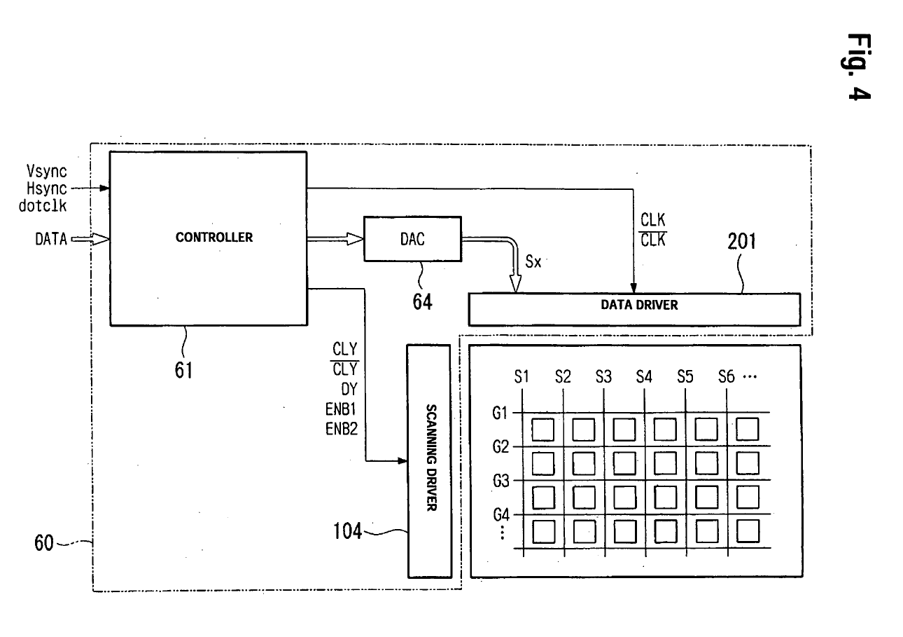

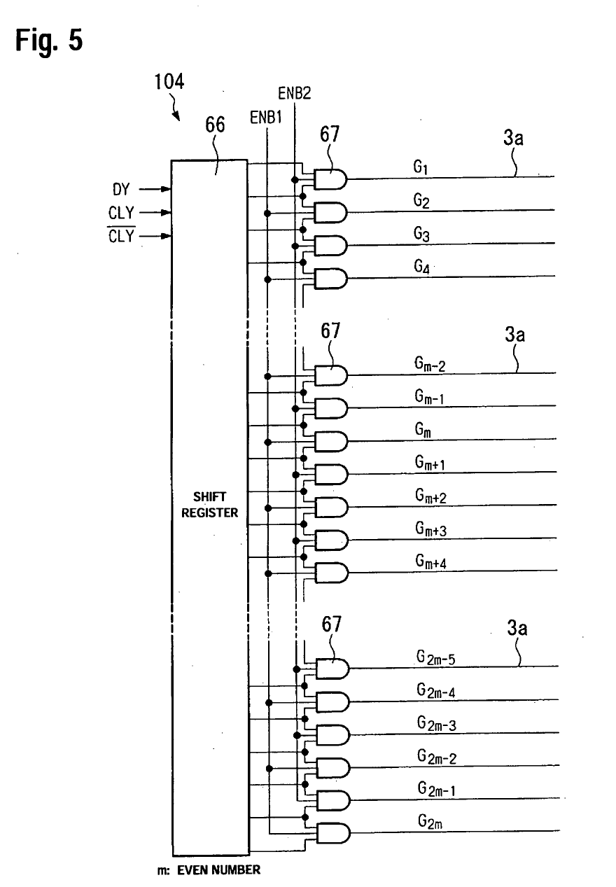

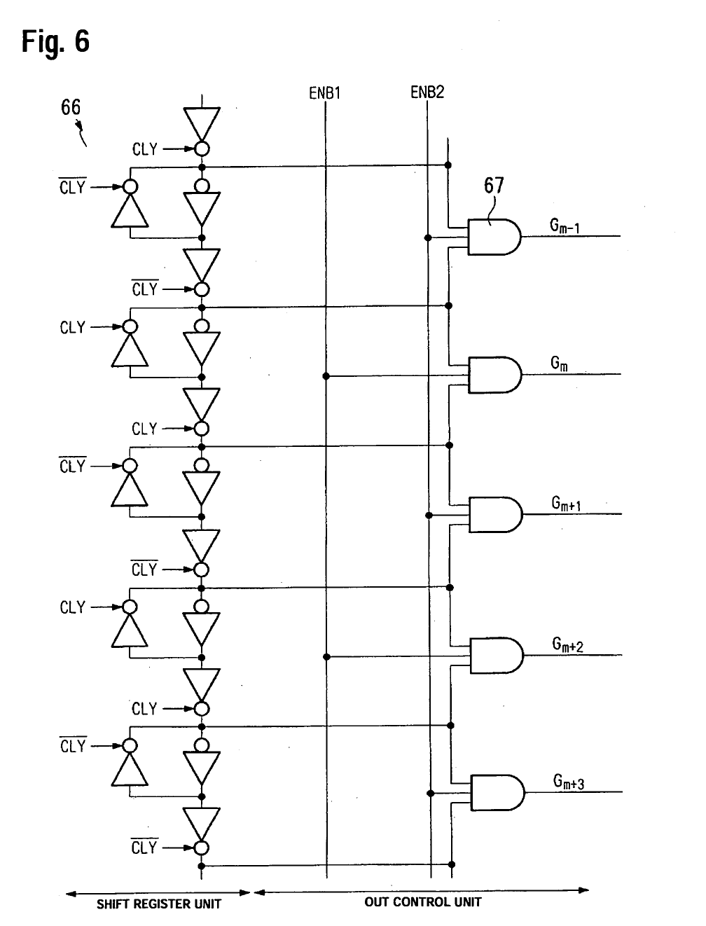

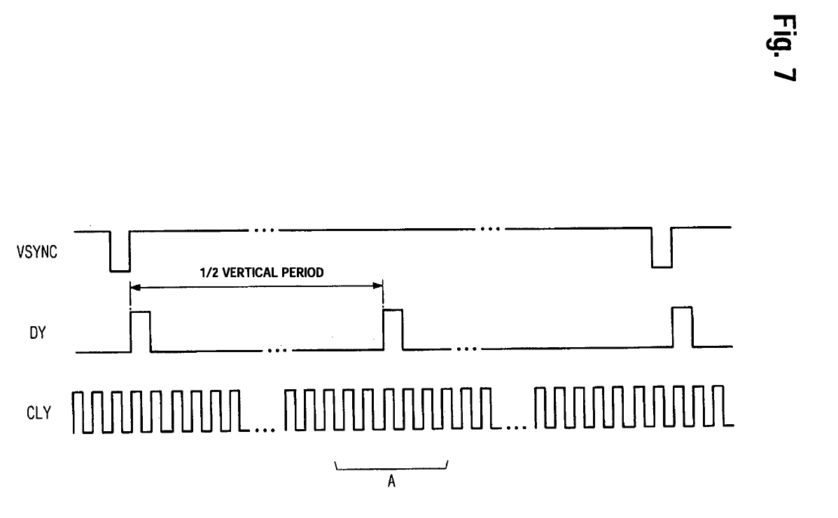

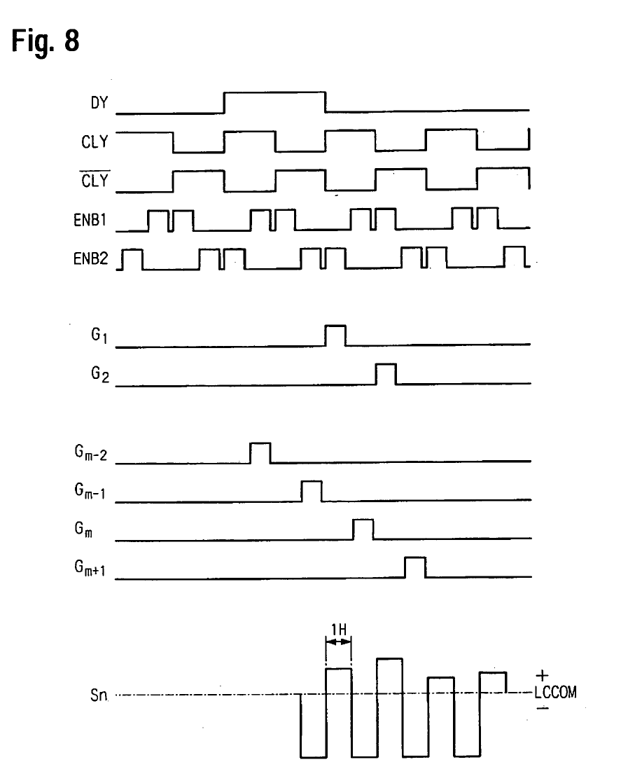

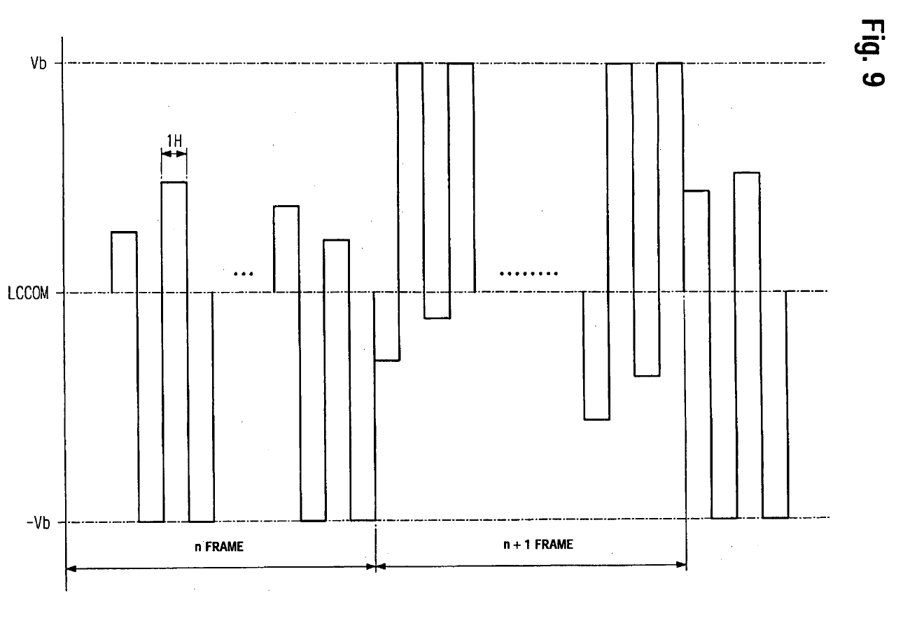

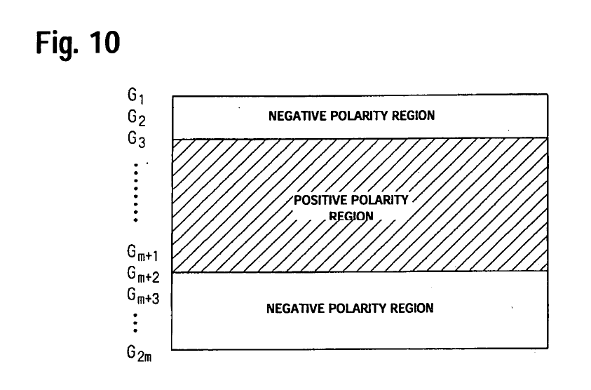

FIG. 1 shows the schematic structure of a liquid crystal light valve according to an embodiment of the invention. FIG. 2 shows a cross-sectional view taken along the line H-H′ of FIG. 1. FIG. 3 shows an equivalent circuit of the plurality of pixels that constitute the liquid crystal light valve and are formed in a matrix. FIG. 4 shows a block diagram including a driving circuit unit. FIG. 5 shows a circuit diagram that represents the structure of a scanning driver in the driving circuit unit. FIG. 6 shows the detailed circuit diagram of the main part of FIG. 5. FIG. 7 shows a timing chart illustrating the operation of the liquid crystal light valve. FIG. 8 shows a timing chart that is abstracted from the main part of FIG. 7. FIG. 9 illustrates an image of a screen. FIG. 10 shows a diagram illustrating the movement of the screen. Moreover, for each diagram, the scales are different for each layer or member to make the layer or member recognizable size on the diagram.

In the configuration of a liquid crystal light valve 1 according to the present embodiment, as shown in FIGS. 1 and 2, a sealing material 52 is disposed along the border of the counter substrate 20 on the TFT array substrate 10, and a light shielding film 53 is provided as a frame inside of it. At the outside region of the sealing material 52, a data driver (data line driving circuit) 201 and external circuit connection terminals 202 are installed along one side of the TFT array substrate 10, and scanning drivers (scanning line driving circuits) 104 is installed along the two sides that are adjacent to one side.

In addition, at the remaining one side of the TFT array substrate 10, multiple wiring lines 105 are installed to connect the scanning drivers 104 that are installed at both sides of the image display region. In addition, for at least a portion of the corner of the counter substrate 20, an upper and lower conducting material 106 is disposed to electrically conduct between the TFT array substrate 10 and the counter substrate 20. In addition, as shown in FIG. 2, the counter substrate 20 that has a nearly same contour as the sealing material 52 in FIG. 1 is fixed to the TFT array substrate 10 by the sealing material 52, and the liquid crystal layer 50 that can include TN liquid crystal or the like is encapsulated between the TFT array substrate 10 and the counter substrate 20. In addition, the opening 52a that is formed in the sealing material 52, shown in FIG. 1, is a liquid crystal injection port, and is sealed by the sealing material 25.

In FIG. 3, for each of the plurality of pixels that constitute the image display region of the liquid crystal light valve 1 of the present embodiment and can be formed in a matrix, a pixel electrode 9 and TFT 30 to perform the switching control of the corresponding pixel electrode 9 are formed, and a data line 6a that is provided with an image signal is electrically connected to a source region of the TFT 30.

The liquid crystal light valve 1 according to the present embodiment has n data lines 6a and 2m scanning lines 3a (where n and m are natural numbers). The image signals S1, S2, . . . , Sn that are written in the data lines 6a may be provided line-sequentially in this order and are provided every group for mutually neighboring multiple data lines 6a.

In addition, the scanning line 3a can be electrically connected in the gate of the TFT 30, the scanning signals G1, G2, . . . , G2m are applied by skipping them to each scanning line 3a at a predetermined timing, which will be described later. The pixel electrode 9 is electrically connected to the drain of the TFT 30, and the image signals S1, S2, . . . , Sn that are supplied from the data lines 6a are written in the electrode at a predetermined timing by turning the state of the switching element TFT 30 on for a constant period. The image signals S1, S2, . . . , Sn with a prescribed level that are written in the liquid crystal via the pixel electrode 9 are held for a constant period between the pixel electrodes and common electrodes that are formed in the counter substrate 20. Herein, a storage capacitor 70 is provided parallel to a liquid crystal capacitor, which is formed between the pixel electrode 9 and the common electrode, so as to prevent the leakage of the holding image signal.

The driving circuit unit 60 of the liquid crystal light valve 1 according to the present embodiment can include a controller 61, a DA converter 64 or the like, in addition to the above-described data driver 201 and scanning driver 104, as shown in FIG. 4. A vertical synchronizing signal Vsync, a horizontal synchronizing signal Hsync, a dot clock signal dotclk, and image data DATA are input to the controller 61, and the controller 61 outputs the image data serving as the image signal to the data driver side.

In addition, the controller 61 outputs the black display data (voltage is ±Vb) to the data driver side to insert a black image into the image, the image signal of one frame can include the image display field data (image signal data) and black display field data. In addition, the data signal of each field has a different polarity centering a predetermined electric potential, and the polarity of these data is inversed every one vertical period. At that time, it cannot be said that the reference electric potential has a constant value.

The scanning driver 104 can include a shift register 66, wherein a gate output pulse DY, a clock signal CLY, an inverse clock signal \overline{CLY} are input from the controller 61, and 2m AND circuits 67 that receives the output from the shift register 66, as shown in FIG. 5. 2m scanning lines 3a are divided into two blocks that consists of the odd-number placed and even-number placed lines from the uppermost region of the image display region, and one of the two enable signals is connected to each output from the shift register 66. In other words, the output from the shift register 66 and an enable signal ENB1 are input to each of the AND circuits 67 corresponding to the even-number placed scanning lines G2, G4, . . . , Gm, Gm+2, . . . , G2m, and the output from the shift register 66 and an enable signal ENB2 are input to each of the AND circuits 67 corresponding to the odd-number placed scanning lines G1, G3, . . . , Gm+1, Gm+3, . . . , G2m−1. FIG. 6 shows the screen center including the internal configuration of the shift register 66.

The operation of the driving circuit unit 60 having the above configuration will be described with reference to FIGS. 7 and 8.

In the driving circuit unit 60, a gate output pulse DY is output once every ½ vertical period (i.e., output twice every one vertical period) according to the writing-in starting time of the image display field and black display field. The gate output pulse DY shift the shift registers 66 of the scanning driver 108 by the clock signal CLY where one pulse rises every one horizontal period. On the other hand, the enable signals ENB1 and ENB2 alternately rise every two horizontal periods in order of ENB1, ENB1, ENB2, ENB2, ENB1, ENB1, ENB2, ENB2, . . . , and the scanning signal for the scanning line that corresponds to the rising location of theses enable signals is output. The gate pulse is alternately output to two regions apart from m scanning lines on the screen using the above operation. In other words, the scanning returns to the next scanning line of the prescribed scanning line after skipping the scanning lines apart from m scanning lines from the prescribed scanning line, and skips the scanning lines apart from m scanning lines from the scanning line and again returns to the next scanning line (i.e., in order of scanning line G1, scanning line Gm+1, scanning line G2, scanning line Gm+2, G3, . . . ,), so that they are output sequentially.

On the other hand, in the data driver 201, as shown in FIG. 9, the image display field data (image data DATA) and black display field data (voltage is ±Vb) of the signals with different polarity are alternately output, the polarity of the field data signal is inversed to the positive polarity electric potential or negative polarity electric potential every one vertical period by the reference electric potential. For example, the common electric potential LCCOM is applied to the liquid crystal device, and the reference electric potential may change every one vertical period. Therefore, the data with inversed polarity is output every one horizontal period in the data driver 201 side, and the gate pulse is alternately output to two regions in the screen apart from m scanning lines in the above order in the scanning driver 104 side.

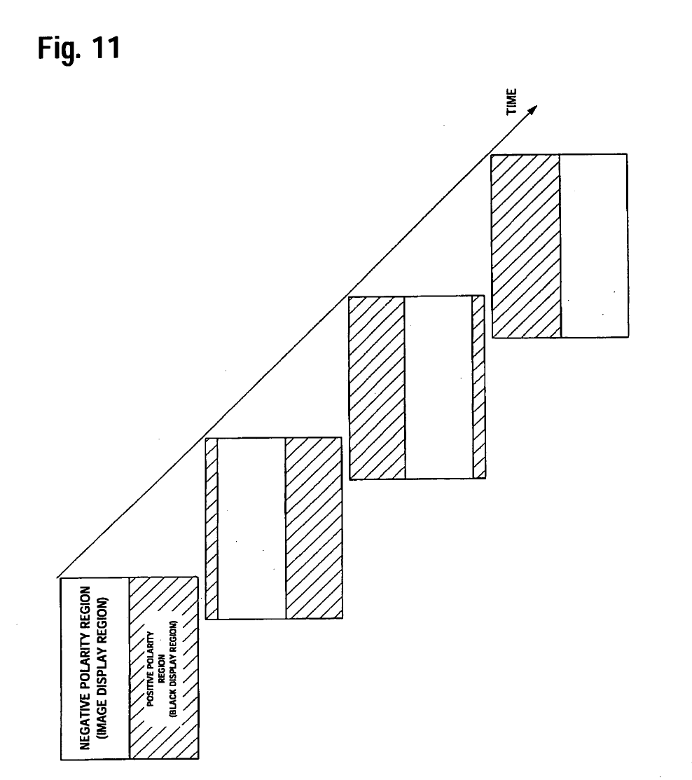

As a result, for example, considering one horizontal period as shown in FIG. 10, the screen is divided into two regions of the positive polarity region and negative polarity region where the data with different polarity is written in so that, on the screen, the dots corresponding to the scanning lines G3 to Gm+2 become the region where the data of the positive polarity electric potential is written in (for example, the region where the black image is displayed) and the dots corresponding to the scanning lines G1 to G2 and Gm+3 to G2m become the region where the data of the negative polarity electric potential is written in (for example, the region where the image is displayed). In addition, as shown in FIG. 11, each region scrolls one line every two horizontal period from the upper screen to lower screen and moves the entire screen during one vertical period. In addition, after the image of one frame is displayed, the polarities of the field data for the image display and field data for the black display are respectively inversed and the writing-in is performed in the same order.

In other words, in the present embodiment, one frame can be divided into a plurality of continuous fields (two in this example), using one of the two continuous fields as the image data and the other as the black display data makes the execution of the impulse-type display possible. When the field image is written in, the writing-in of the image of the next field begins in the midst of the writing-in of the image of the previous field, unlike the conventional field-inversion driving method that the writing-in of the image of the next field begins after writing-in the image of the previous field. As a result, the applied regions of the positive electric potential and negative electric potential with some extent of width are formed in the screen so as to correspond to each field.

In the present embodiment, the positive polarity region and the negative polarity region with half width of the screen are accordingly inversed during one vertical period, resulting in the field-inversion driving every region. During one vertical period, while the polarity of the electric potential is inversed as much as the interval of 2/2m between one arbitrary dot and one neighboring dot, the polarity of the electric potential is same during the remaining interval of (2 m−2)/2m, resulting in little discrimination. On the other hand, as shown in the signal waveform of FIGS. 8 and 9, almost same operation for the data line 6a side as the conventional line-inversion driving for the signal polarity is executed. As a result, there is a little difference between the potentials of the pixel electrode and the data line in upper and lower pixels of the screen like the conventional field-inversion driving method, and the display non-uniformity according to the region in the screen can be avoided while suppressing the crosstalk.

Moreover, in this invention, since the boundary between the image display region and the black display region is scanned every two horizontal period, it cannot be recognized to the human eyes, and it does not deteriorate the performance.

In addition, in the present embodiment, since one frame data is divided into two continuous field data and one field data uses externally input image data itself, the image is in fact written in with double speed (that is, frequency of two times of that of the externally input image data). Usually, although double-speed driving requires the frame memory corresponding to two screens, outputting the external image data to the data line forms the image in this configuration, the use of the frame memory can be omitted.

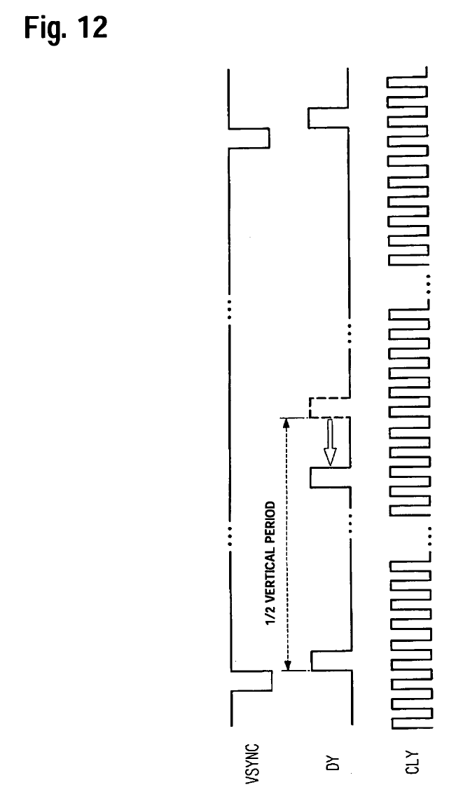

Hereinafter, the second preferred embodiment of the present invention will be described with reference to the FIGS. 12 to 14.

The basic configuration of the liquid crystal light valve (the liquid crystal device) of the present embodiment is the same as that of the first preferred embodiment except that variable control of the output interval of the gate output pulse can be performed.

As stated above, since the image display data and black display data are alternately written in during the one vertical period, the image display and black display regions always exist in the screen, and the image of the previous written field (for example, the black display field) is sequentially rewritten in by the image of the later written field (for example, the image display field). For example, when the writing-in of the black field starts and then the writing-in of the image field starts at the stage that is scanned until the k-th line (i.e., after 2k horizontal period), the previously written black images of 1 to k-th lines are rewritten in by the image between the 2k horizontal periods afterwards. In other words, the previous written field data is not held in the screen outside the k lines.

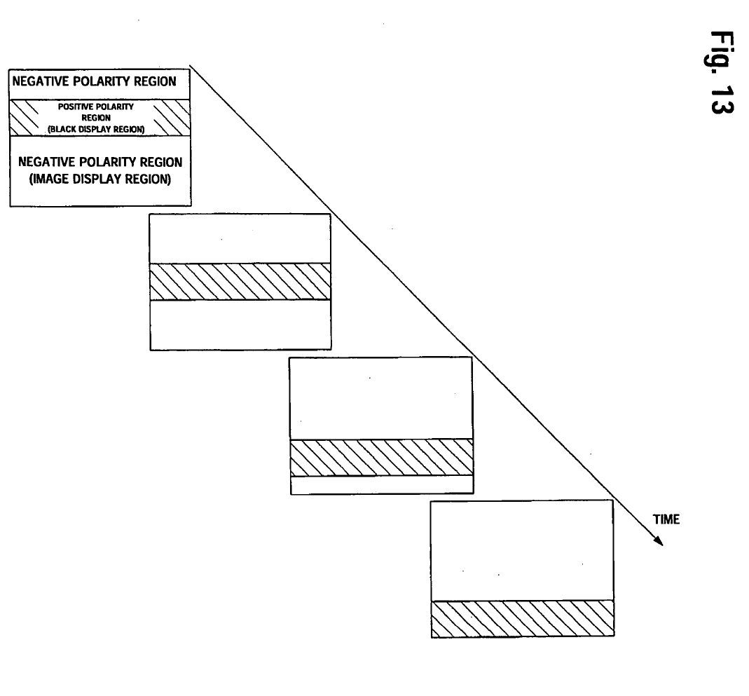

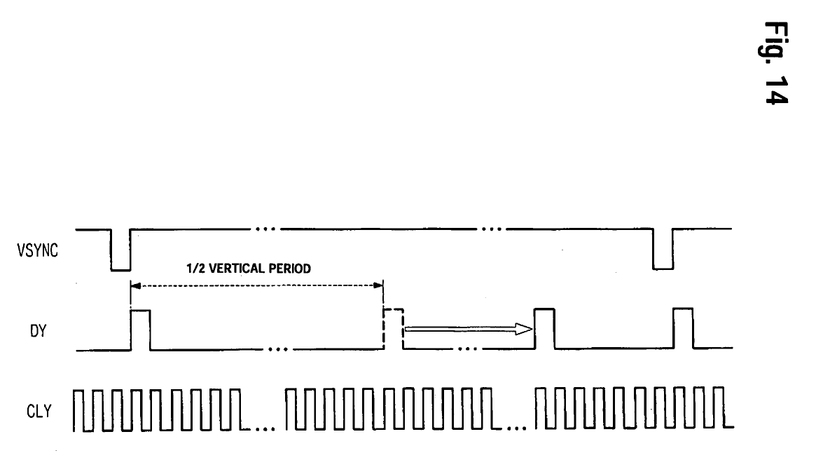

As a result, for example, as shown in FIG. 12, reducing the output interval of two gate output pulses decreases the area of the black display region compared to the image display region, making the display brighter, as shown in FIG. 13. In contrast, as shown in FIG. 14, increasing the output interval of the gate output pulse increases the area of the black display region, making the display darker. Since there is a tradeoff relationship between the holding period of the black field and display brightness, the output interval of the gate output pulse (i.e., interval at the starting time for the writing-in of each field) can be variably controlled based on the external information (for example, information based on the image signal, information based on the projection magnification, information based on the circumferential brightness, and information based on the user preference), and then the optimum display can be performed.

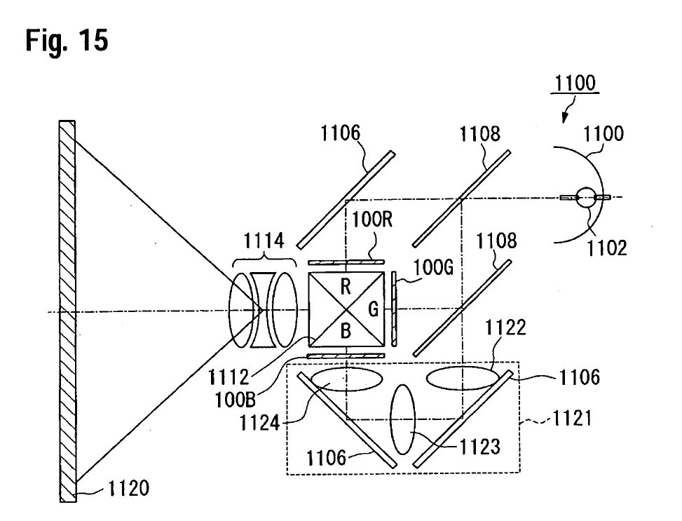

FIG. 15 shows the schematic configuration of an example of, so called, the 3-panel projection-type liquid crystal display device (liquid crystal projector) using three liquid crystal light valve according to the embodiment of the invention. In this diagram, the reference numerals 1100, 1108, and 1106 represent a light source, dichroic mirrors, reflecting mirrors, respectively. The reference numerals 1122, 1123, and 1124 represent relay lens. The reference numerals 100R, 100G, and 100B represent liquid crystal light valves. The reference numerals 1112 and 1114 represent cross-dichroic prisms and a projection lens system, respectively.

The light source 1100 can include a metal-halide lamp 1102 and a reflector 1101 that reflects light of the lamp 1102. The dichroic mirror 1108 that reflects blue light and green light components transmits only red light and reflects blue light and green light components among white light of the light source 1100. The transmitted red light is reflected from the reflecting mirror 1106 and then is incident on the liquid crystal light valve 100R for red light.

On the other hand, among the reflected light components from the dichroic mirror 1108, green light is reflected by the dichroic mirror 1108 that reflects green light and is incident on the liquid crystal light valve 100G for green light. In addition, blue light also transmits the second dichroic mirror 1108. For the case of blue light, the light-guiding means 1121 composed of a relay lens system that comprises the incident lens 1122, the relay lens 1123, and the emitting lens 1124 is provided to compensate for the difference between the light paths of green and red light components and the blue light component. Finally, blue light is incident on the liquid crystal light valve 100B for blue light by the light-guiding means 1121.

Three light components that are modulated by each liquid crystal light valves 100R, 100G, and 100B are incident on the cross-dichroic prism 1112. Connecting four orthogonal prisms to each other, wherein a dielectric multilayer film that reflects red light and a dielectric multilayer film that reflects blue light are formed in a cross, forms the cross-dichroic prism. These dielectric multilayer films synthesize three light components, and light for displaying color image is formed. The synthesized light is projected on the screen 1120 by the projection lens system 1114 corresponding to the projection optical system and an image is then magnified and displayed.

In the projection-type liquid crystal display device having the above configuration, using the liquid crystal light valves of the preferred embodiment can implement the projection-type liquid crystal display device with excellent display uniformity.

Moreover, it should be understood that the invention is not limited to the above-mentioned embodiments and various changes may be made without departing from the spirit and scope of the present invention. For example, although one frame data is divided into two field data for the image display and black display in the embodiment, the present invention is not limited thereto and one frame data can further be divided into more than three continuous field data in the present invention. In this case, each field data may be alternately written in every one horizontal period by skipping the starting time of the writing-in of the field within one vertical period. At least one field data is also assigned for the black display data, and the polarity of the data is inversed between continuous fields.

In further details, the scanning driver outputs n gate output pulses corresponding to the field numbers (for example, n) within one vertical period at different timing, and alternately shifts every one horizontal period in synchronization with the clock signal. At this time, one of the n enable signals that alternately rise every horizontal period is assigned for each scanning line. The scanning line outputs for the selected scanning line from the gate output pulses and enable signals. In addition, for the data driver, the field data are alternately provided every one horizontal period for each data line.

In addition, although described is the active matrix-type liquid crystal device using TFT as an example in the preferred embodiment, it should be understood that the invention is not limited thereto, and can be applied to various display devices that drive a plurality of pixels, such as the device using a TFD (Thin Film Diode) in the pixel switching element, a passive matrix-type device, etc.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. An electro-optical device, comprising:
a plurality of pixels arranged in an image display region; and
a driving circuit unit that drives the pixels,
the driving circuit unit dividing data of one frame into a plurality of data corresponding to a plurality of fields, one of data of two continuous field being data corresponding to an image signal and the other being data corresponding to black level signal,
data of two continuous fields being alternately written in every one horizontal period while changing a starting time of a writing-in of each field within one vertical period, and
a polarity of the data signal being inversed against a predetermined electric potential between the continuous two fields.

2. The electro-optical device according to claim 1,
the driving circuit unit inversing the polarity of data for each field every one vertical period.

3. The electro-optical device according to claim 1,
the starting time for the writing-in of each field being variably controlled.

4. An electro-optical device, comprising:
a plurality of data lines and a plurality of scanning lines disposed to intersect each other;
a plurality of pixels arranged correspondingly to the intersections of the plurality of data lines and the plurality of scanning lines; and
a driving circuit unit that drives the pixels, the driving circuit unit, comprising:
a scanning driver that outputs n gate output pulses within one vertical period at a different timing and that shifts gate output pulses to the scanning lines apart from a predetermined interval every one horizontal period in synchronization with clock signals; and
a data driver that divides one frame data into n data corresponding to continuous n fields, alternately provides each data line with n data for continuous n fields every one horizontal period, and inverses a polarity of data signals between the continuous fields centering a predetermined electric potential,
one of n enable signals that alternately are generated every one horizontal period being provided to each scanning line; and
the scanning signal being output for the scanning line selected from the gate output pulses and enable signals; and
one of the n data corresponding to black level signal.

5. The electro-optical device according to claim 4, the data driver inversing the polarity of each field data every one vertical period.

6. The electro-optical device according to claim 4, an output timing of the plurality of gate output pulses being variably controlled.

7. The electro-optical device according to claim 1, the data driver dividing one frame into two continuous fields, one of the two fields being for the image data and the other being for black display data.

8. A method of driving an electro-optical device in which a plurality of pixels are arranged in an image display region, the method comprising:
dividing one frame into a plurality of continuous fields, one of two continuous field data being data corresponding to an image signal and the other being data corresponding to black level signal,
alternately writing the two continuous field data in every one horizontal period while changing a starting time of the writing-in of each field within one vertical period, and
inversing a polarity of data signals between the continuous fields centering a predetermined electric potential.

9. A projection-type display device, comprising:
an illumination device;
an electro-optical device according to claim 1 that modulates light emitted from the illumination device; and
a projection device that projects light modulated by the electro-optical device.

10. An electronic apparatus, comprising:
electro-optical device according to claim 1.
